(19) United States
(12) Patent Application Publication
(10) Pub. No.: US 2022/0318694 A1
(43) Pub. Date: Oct. 6, 2022

(54) MOVEMENT PREDICTION DEVICE, MOVEMENT PREDICTION METHOD, AND MOVEMENT PREDICTION PROGRAM

(71) Applicant: NIPPON TELEGRAPH AND TELEPHONE CORPORATION, Tokyo (JP)

(72) Inventors: Maiko NAYA, Tokyo (JP); Masamichi HOSODA, Tokyo (JP); Akira NAKAYAMA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/639,314

(22) PCT Filed: Sep. 2, 2019
(86) PCT No.: PCT/JP2019/034413

§ 371 Date: Feb. 28, 2022

(51) Int. Cl. G06Q 10/04

(52) U.S. Cl. CPC G06Q 10/047

(57) ABSTRACT

An interaction based on a difference in a travelling direction is simulated, and a simulation of movement can be accurately performed. A head count ratio between a head count of the moving agents travelling in one direction and a head count of the moving agents travelling in another direction for each direction at a selected edge is obtained, a width size relative to a proceeding direction of the moving agent is calculated from the head count ratio relative to a width of the edge, and a population density is calculated with respect to each of the moving agents based on an area of a section which is obtained from a forward area length from a location of the moving agent and the width size calculated for the proceeding direction of the moving agent and the moving agents existing in the section for each direction. With regard to each of the moving agents, a movement speed of the moving agent is calculated based on the free walking speed of the agent information, the calculated population density, and a predetermined parameter.

### TECHNICAL FIELD

A disclosed technology relates to a movement prediction device, a movement prediction method, and a movement prediction program.

### BACKGROUND ART

Up to now, a technique has been proposed for predicting a situation where a large number of people move by a simulation.

For example, a technique has been proposed for obtaining a movement speed of each agent (see Non-Patent Literature 1).

### CITATION LIST

### Non-Patent Literature

Non-Patent Literature 1: Junji In-nami, Takayoshi Shogaki, Fumihiko Kakehi, Kiyoshi Fukui, and Takeshi Yamada. Pedestrian simulation study to evaluate the effect of evacuation guidance around the large-scale terminal station. Proceedings of infrastructure planning, Vol. 45, June 2012.

### SUMMARY OF THE INVENTION

### Technical Problem

However, a problem occurs that a prediction accuracy is not sufficient since an interaction of people passing each other at an edge cannot be taken into account.

It is an object of the present disclosure to provide a movement prediction device, a movement prediction method, and a movement prediction program, that can accurately perform a simulation of movement by simulating an interaction based on a difference in a travelling direction.

### Means for Solving the Problem

A first aspect of the present disclosure is a movement prediction device including: an agent generation unit configured to accept inputs of edge information related to each of edges indicating paths connecting respective nodes, and agent information with regard to each of a plurality of agents which sets a departure time of day, a point of departure among the respective nodes, a point of destination among the respective nodes, and a free walking speed of the agent, and record each of moving agents departing from the point of departure in accordance with the departure time of day of the agent information; an edge selection unit configured to select, with regard to each of the moving agents, an edge through which the moving agent moves based on a location of the agent, the point of destination of the agent information, and the edge information; a forward area density calculation unit configured to obtain a head count ratio between a head count of the moving agents travelling in one direction and a head count of the moving agents travelling in another direction for each direction at the selected edge, and calculate a width size relative to a proceeding direction of the moving agent from the head count ratio relative to a width of the edge, and calculate, with respect to each of the moving agents, a population density based on an area of a section which is obtained from a previously set length of a forward area from the location of the agent and the width size calculated for the proceeding direction of the moving agent and the moving agents existing in the section for each direction; a movement speed calculation unit configured to calculate, with regard to each of the moving agents, a movement speed of the moving agent based on the free walking speed of the agent information, the calculated population density, and a predetermined parameter; a location update unit configured to update, with regard to each of the moving agents, the location of the moving agent based on the calculated movement speed; and a determination unit configured to repeat a simulation based on each processing of the agent generation unit, the edge selection unit, the forward area density calculation unit, the movement speed calculation unit, and the location update unit until a predetermined condition is satisfied.

A second aspect of the present disclosure is a movement prediction method characterized in that a computer executes processing including: accepting inputs of edge information related to each of edges indicating paths connecting respective nodes, agent information with regard to each of a plurality of agents which sets a departure time of day, a point of departure among the respective nodes, a point of destination among the respective nodes, and a free walking speed of the agent; recording each of moving agents departing from the point of departure in accordance with the departure time of day of the agent information; selecting, with regard to each of the moving agents, an edge through which the moving agent moves based on a location of the agent, the point of destination of the agent information, and the edge information; obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge; calculating, with respect to each of the moving agents, a population density based on an area of a section which is obtained from a previously set length of a forward area from the location of the agent and the width size calculated for the proceeding direction of the moving agent and the moving agents existing in the section for each direction; calculating, with regard to each of the moving agents, a movement speed of the moving agent based on the free walking speed of the agent information, the calculated population density, and a predetermined parameter; updating, with regard to each of the moving agents, the location of the moving agent based on the calculated movement speed; and repeating a simulation based on each processing until a predetermined condition is satisfied.

A third aspect of the present disclosure is a movement prediction program for causing a computer to execute: accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of the agent; recording each of moving agents departing from the point of departure in accordance with the departure time of day of the agent information; selecting, with regard to each of the moving agents, an edge through which the moving agent moves based on a location of the agent, the point of destination of the agent information, and the edge information; obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge; calculating, with respect to each of the moving agents, a population density based on an area of a section which is obtained from a previously set length of a forward area from the location of the agent and the width size calculated for the proceeding direction of the moving agent and the moving agents existing in the section for each direction; calculating, with regard to each of the moving agents, a movement speed of the moving agent based on the free walking speed of the agent information, the calculated population density, and a predetermined parameter; updating, with regard to each of the moving agents, the location of the moving agent based on the calculated movement speed; and repeating a simulation based on each processing until a predetermined condition is satisfied.

### Effects of the Invention

According to the disclosed technology, it is possible to accurately perform the simulation of the movement by simulating the interaction based on the difference in the travelling direction.

### BRIEF DESCRIPTION OF DRAWINGS

FIG. 1 is a block diagram illustrating a configuration of a movement prediction device according to the present embodiment.

FIG. 2 is a block diagram illustrating a hardware configuration of the movement prediction device.

FIG. 3 is a flowchart illustrating a flow of movement prediction processing by the movement prediction device.

### DESCRIPTION OF EMBODIMENTS

Hereinafter, one example of an embodiment of a disclosed technology will be described with reference to the drawings. It is noted that the same or equivalent components and parts in the respective drawings are assigned with the same reference signs. In addition, a scale ratio of the drawings may be exaggerated for convenience of explanations, and may be different from an actual ratio.

First, a background of the present disclosure and a technology as a premise will be described, and thereafter an outline of the present disclosure will be described.

In a large scale event or the like, congestion may occur because a large number of people gather and cannot smoothly move to a point of destination. In addition, in such a situation, a dangerous state may also occur which leads to an accident. As measures against the above-described problem, as a preliminary review, discussions are made on where a crowded location and a time slot are, how the congestion can be alleviated by guidance, a possibility of trouble and its measures, and the like. At this time, to check how a flow of people (hereinafter, a people flow) changes, a simulation of a situation where a large number of people move is performed using a people flow simulator.

Several methods are proposed for the people flow simulators. For example, a multi agent simulation (hereinafter, MAS) has been proposed in which respective pedestrians are set as agents. Among these, a simulator has been proposed which performs a simulation based on a detailed physical model in which physical shapes of paths and an intersection are reproduced in detail on a simulator, and a wide variety of characteristics are individually applied to each of the respective agents. However, a problem occurs that it takes a large calculation amount and a large memory capacity to implement the simulation, and it takes time. On the other hand, as a simple model, a method of reproducing a path network by a model in which a path is set as an edge, and a location where a path branches and paths are merged is set as a node (hereinafter, referred to as a node edge model) has been proposed (see Non-Patent Literature 1). According to this method, behaviors of the agents are also set as a simple speed model to reduce the calculation amount, and a high speed simulation is performed.

According to Non-Patent Literature 1, each agent's own movement speed vᵢ [m/s] is determined by the following Expression (1).

$$[ Math . 1 ]$$

$${v}_{i} = \{ \begin{matrix}{V}_{i} & ( 0 \leq ρ \leq {ρ}_{i} ) \\ 1.8 {ρ}^{- 1} - 0.3 & ( {ρ}_{i} \leq ρ \leq 6. ) \\ 0 & ( ρ \geq 6. )\end{matrix} \qquad ( 1 )$$

Where, ρ denotes a population density [people/m²] in an agent's forward area L [m]. In a case where a width size of the agent's forward area L [m] is denoted by W [m], and a head count (the number of other agents) therein is denoted by N [people], the population density ρ corresponds to the following Expression (2).

$$[ Math . 2 ]$$

$$ρ = \frac{N}{L \times W} \qquad ( 2 )$$

The single forward area L is set in the entirety, and the width size W denotes a width of an edge where the agent exists.

ρᵢ denotes a density that satisfies Vᵢ=1.8ρᵢ⁻¹−0.3, and denotes a density individually set for the agent based on a free walking speed Vᵢ. L is set as 6 m according to Non-Patent Literature 1, and W is set for each edge.

Thus, such a situation is reproduced that each agent moves at the individually set free walking speed Vᵢ (highest speed) when the forward area is clear, and the speed is decreased in accordance with the density as the forward area starts to be congested, and stoppage occurs in a case where the congestion is equal to or higher than a certain level.

In addition, to reflect human attributes such as an age and the presence or absence of locality on the agents, the free walking speed Vᵢ individually set for each of the agents is changed, and a simulation where those are mixed can be performed. In addition, a simulation where a ratio, a distribution, or the like of mixture of the respective attributes is changed can also be performed.

Of course, a technique for performing a complication calculation including an interaction of people passing each other and an action for evacuating to a side of a street to overtake a person in the forward area has been proposed for a simulator that simulates movement of people, but this calculation technique takes time because the calculation is complex. It is conceivable to cope with an increase in a speed of the calculation by treating an edge as a one-way street and preparing two edges of one-way streets for representing the passing. However, the interaction of mutual people such as a decrease in the speed because of the presence of a passing person cannot be represented by simply preparing the two edges of one-way streets. In view of the above, a representation method of simulating the passing by mutual people is desirably to be established while the increase in the calculation speed is maintained.

In view of the above, according to the present embodiment, in the simulation of the node edge model, the width size relative to each travelling direction is calculated, and the calculation of the population density is performed using the width sizes calculated for the directions.

Hereinafter, a configuration of the present embodiment will be described.

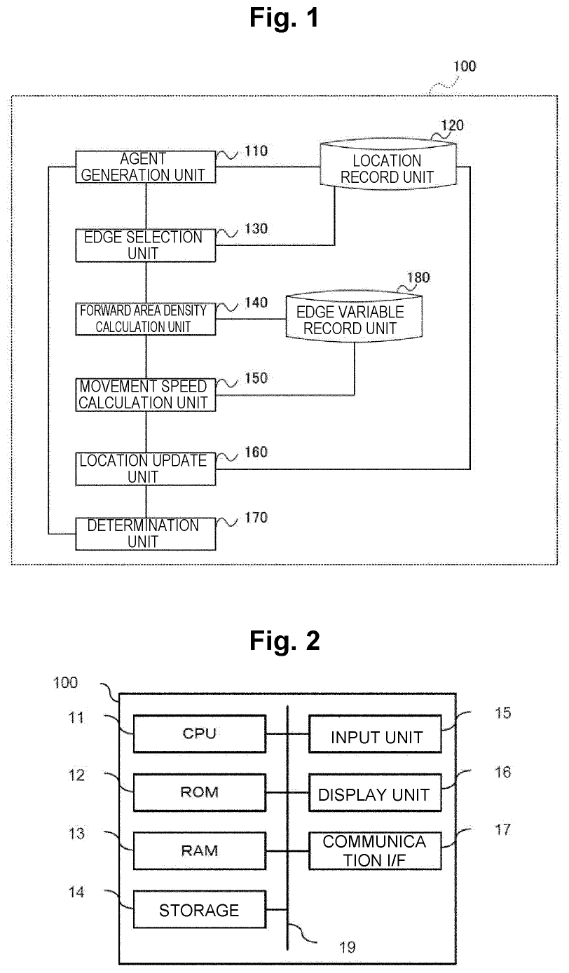

FIG. 1 is a block diagram illustrating a configuration of a movement prediction device according to the present embodiment.

As illustrated in FIG. 1, a movement prediction device 100 is configured by including, as processing units, an agent generation unit 110, an edge selection unit 130, a forward area density calculation unit 140, a movement speed calculation unit 150, a location update unit 160, and a determination unit 170. In addition, the movement prediction device 100 is configured by including, as record units, a location record unit 120 and an edge variable record unit 180.

FIG. 2 is a block diagram illustrating a hardware configuration of the movement prediction device 100.

As illustrated in FIG. 2, the movement prediction device 100 includes a CPU (Central Processing Unit) 11, a ROM (Read Only Memory) 12, a RAM (Random Access Memory) 13, a storage 14, an input unit 15, a display unit 16, and a communication interface (I/F) 17. The respective configurations are connected via a bus 19 to be mutually communicable.

The CPU 11 is a central processing unit and configured to execute various types of programs and control respective units. That is, the CPU 11 reads out the program from the ROM 12 or the storage 14, and executes the program using the RAM 13 as a work area. The CPU 11 performs control of the above-described respective configurations and various types of arithmetic processing in accordance with the program stored in the ROM 12 or the storage 14. According to the present embodiment, the ROM 12 or the storage 14 stores a movement prediction program.

The ROM 12 stores various types of programs and various types of data. The RAM 13 temporarily stores the program or data as the work area. The storage 14 is configured by an HDD (Hard Disk Drive) or an SSD (Solid State Drive), and stores various types of programs including an operating system and various types of data.

The input unit 15 includes a pointing device such as a mouse and a keyboard, and is used for performing various types of inputs.

The display unit 16 is, for example, a liquid crystal display, and displays various types of information. The display unit 16 may adopt a touch panel method to function as the input unit 15.

The communication interface 17 is an interface configured to communicate with other devices such as a terminal, and a standard such as Ethernet (registered trademark), FDDI, or Wi-Fi (registered trademark) is used, for example.

Next, respective functional configurations of the movement prediction device 100 will be described. The respective functional configurations are realized when the CPU 11 reads out the movement prediction program stored in the ROM 12 or the storage 14 to be developed and executed on the RAM 13.

The movement prediction device 100 accepts agent information and edge information as inputs.

For the agent information, agent numbers i (i=serial numbers of 1, 2, 3, m) are respectively assigned to all agents (all pedestrians). As the agent information, for each agent, a departure time of day, a node number of a point of departure, a node number of a point of destination, and the free walking speed Vᵢ are set. The point of departure is a point of departure among the respective edges indicating the paths. The point of destination is a point of destination among the respective edges indicating the paths.

The edge information is information related to each of the edges in which an origin node number, a terminal node number, a vertical width L, a horizontal width W, and parameters α, β, and γ of a speed coefficient are set with regard to all the edges. To increase the speed of the calculation, two pieces of edge information connecting the same nodes may be prepared for respective directions. In other words, an edge connecting a node number 1 and a node number 2 has two pieces of edge information including edge information of “an origin node number 1 and a terminal node number 2”, and edge information of “an origin node number 2 and a terminal node number 1”. The former is used by an agent travelling in a direction from the node number 1 to the node number 2, and the latter is used by an agent travelling in a direction from the node number 2 to the node number 1.

The movement prediction device 100 uses the agent generation unit 110, the edge selection unit 130, the forward area density calculation unit 140, the movement speed calculation unit 150, and the location update unit 160 as simulators, and executes a simulation. The movement prediction device 100 stores information indicating that all the agents have not yet departed in the location record unit 120 before the simulation execution, and then starts the simulation. Then, at each time of day, the movement prediction device 100 repeats processing for performing the calculation at t=0, for example, by setting a second as a unit, and when it is completed, performing the calculation at t=1 that is one second later. In a case of the simulation for j seconds by setting an execution time as j, when the movement prediction device 100 completes the calculation at t=j, the simulation is completed. Hereinafter, the respective units of the movement prediction device 100 will be described. Hereinafter, an operation at the time of t=k will be described as the operation performed at each time of day.

The agent generation unit 110 records each of the moving agents departing from the point of departure in accordance with the departure time of day of the agent information in the location record unit 120. Hereinafter, an agent who makes a move recorded in the location record unit 120 is referred to as a moving agent. Hereinafter, an operation example of the agent generation unit 110 will be described.

First, the agent generation unit 110 searches for an agent who has a departure time of day at k from among all the agents of the agent information. For the location record unit 120, the agent generation unit 110 records the agent number of the relevant agent at the time of day of t=k, the location information, and information indicating that the agent has departed by the searching. The moving agent can be tracked as a result of the recording. The location information is a combination of a “node number passed at the end”, a “node number expected to be passed next”, and a “distance travelled from the node passed at the end”. In other words, at the time of the departure, the location information including the node number of the point of departure of the agent information as the “node number passed at the end”, not yet determined as the “node number expected to be passed next”, and 0 as the “distance from the node passed at the end” is recorded. These pieces of location information are recorded with regard to each time of day by the simulation. The “node number passed at the end” is the location of the moving agent referred to in the processing of the edge selection unit 130.

With regard to each of the moving agents, the edge selection unit 130 selects the edge through which the moving agent moves based on the location of the moving agent, the point of destination of the agent information, and the edge information. Hereinafter, an operation example of the edge selection unit 130 will be described.

First, the edge selection unit 130 obtains the location information with regard to all the moving agents who are currently walking (who have already departed and have not yet reached) from the location record unit 120. In a state where the “node number expected to be passed next” in the obtained location information is not yet determined, in other words, which edge to be travelled is not selected, the edge selection unit 130 refers to the edge information to search for edges connected to the node, and selects which edge is to be travelled among those. The edge selection unit 130 stores the terminal node number in the edge information of the selected edge in the “node number expected to be passed next” of the location information. A method for the selection is optional, but the edge selection unit 130 searches for and selects an edge where the point of destination can be reached at the closest distance, for example. In addition, the edge selection unit 130 may randomly select the edge such that a probability for the edge to be selected is higher which has a shorter distance to reach the point of destination, or may randomly select the edge such that any edge has the same probability.

The forward area density calculation unit 140 obtains the head count ratio between the head count of the moving agents travelling in one direction and the head count of the moving agents travelling in the other at the selected edge for each direction. Next, the forward area density calculation unit 140 calculates the width size relative to the direction in which the moving agent proceeds from the head count ratio relative to the width of the edge. The width size relative to the proceeding direction is a size width in the one direction and a size width in the other direction. A principle for obtaining the width size relative to the proceeding direction will be described below.

Then, the forward area density calculation unit 140 calculates the population density p with regard to each of the moving agents. First, the forward area density calculation unit 140 obtains an area of a section from the length L of the forward area from the location of the agent and the width size (W_{X} or W_{Y}) calculated relative to the direction in which the agent proceeds. The forward area density calculation unit 140 calculates the population density ρ based on the obtained area of the section and the head count (m or n) of the moving agents for each direction who exist in the section at the distance L [m] of the forward area from the location where the moving agent exists. The length L of the forward area is set, for example, as 6 m. Hereinafter, an operation example of the forward area density calculation unit 140 will be described.

Here, a calculation technique for the width size relative to the direction in which the moving agents proceed in the forward area density calculation unit 140 will be described. When the width W in Expression (2) is divided into two directions, the forward area density calculation unit 140 calculates the width sizes W_{X} and W_{Y} for the respective directions by the head count ratio between the head count of the moving agents travelling in one certain direction and the head count of the moving agents travelling in an opposite direction to the direction. Hereinafter, an X direction and a Y direction corresponding to an opposite direction to the X direction are considered. The head count travelling through the edge in the X direction is set as m, and the head count travelling through the edge in the Y direction is set as n. Whether the moving agent proceeds in the X direction or proceeds in the Y direction may be set by referring to the node number of the point of departure and the node number of the point of destination in the agent information of the moving agent who exists at the edge. In addition, a width size used by m people proceeding in the X direction is set as W_{X}, a width size used by n people proceeding in the Y direction is set as W_{Y}, and a deviation coefficient of the head count ratio is set as k. The deviation coefficient k may be set for each edge, or may be a single value as a whole.

First, W=W_{X}+W_{Y} is exemplified as a restriction condition. Then, W_{X} and W_{Y} are calculated to satisfy the restriction condition in the following Expression (3-1).

[Math. 3]

W_{X}: W_{Y}=m^{k}:n^{k}

W_{X}n^{k}=W_{Y}m^{k}

W_{X}n^{k}=(W−W_{X})m^{k} (3-1)

The width size W_{X} can be calculated by the following Expression (3-2).

$$[ Math . 4 ]$$

$${W}_{X} = \frac{{Wm}^{k}}{{n}^{k} + {m}^{k}} \qquad ( 3 - 2 )$$

The width size W_{Y} can be calculated by the following Expression (3-3).

$$[ Math . 5 ]$$

$${W}_{Y} = \frac{{Wn}^{k}}{{n}^{k} + {m}^{k}} \qquad ( 3 - 3 )$$

With regard to each of the moving agents, in accordance with the travelling direction, the forward area density calculation unit 140 replaces the above-described the width W in Expression (2) with the width size W_{X} or the width size W_{Y} and replaces a head count N with the head count m or the head count n to calculate the population density ρ. Whether to use either the width size W_{X} or the width size W_{Y} or whether to use either the head count m or the head count n may be referred to the travelling direction of the moving agents which is set when the head counts m and n are obtained.

In a case where the distance from the location of the moving agent to the edge terminal is shorter than L [m], a section up to the edge terminal may be set as a section of the population density calculation. In addition, when another edge is connected to the node of the edge terminal, the population density calculation may be performed by including up to any of the edges at the connection destination and obtaining the area of the section across the edges.

A calculation example of the population density will be described. An edge having the length of 25 m and the width W=2 [m] in the travelling direction (hereinafter, set as a width size W′) is supposed. Five moving agents A to E exist at the edge. Respective locations are as follows. The agent A is at the location 10 m away from the edge origin. The agent B is at the location 14 m away from the edge origin. The agent C is at the location 15 m away from the edge origin. The agent D is at the location 19 m away from the edge origin. The agent E is at the location 22 m away from the edge origin.

In this case, when L=6 [m], in the population density calculation of the agent A, two people B and C are set as calculation targets who are up to 16 m corresponding to 6 m ahead of the forward area from 10 m where A in question exists, in other word, who are in locations from 10 m to 16 m. A in question is excluded from the targets, and D and E are ahead by more than the length of 6 m of the forward area and are therefore excluded from the targets.

In a case where W′=2 is set, the area used for the population density calculation of the agent A is L×W′=6×2=12 m². According to a related art method for the calculation using only the head count, the population density can be calculated as the head count/the area=2/12=0.167 people/m².

In addition, in the population density calculation of the agent B, two people C and D are set as calculation targets who are up to 20 m corresponding to 6 m ahead of the forward area from 14 m where B in question exists, in other word, who are in locations from 14 m to 20 m. A existing in a backward area of B, B in question, and E existing ahead by more than 6 m are excluded from the targets. This is the calculation example of the population density.

The movement speed calculation unit 150 calculates the movement speed of the moving agent with regard to each of the moving agents. The movement speed calculation unit 150 calculates the movement speed of the moving agent based on the free walking speed Vᵢ of the agent information, the population density ρ calculated by the forward area density calculation unit 140, and the parameters of the speed coefficient. Hereinafter, an operation example of the movement speed calculation unit 150 will be described.

The movement speed calculation unit 150 calculates the movement speed vᵢ of the moving agent for each moving agent. This calculation uses a rewritten expression as in the following Expression (4) to simulate mutual people's passing.

[Math. 6]

vᵢ=γmax(0,min(Vᵢ,αρ⁻¹−β)) (4)

In Expression (4), max and min are set as follows.

$$max ( x , y ) = \{ \begin{matrix}x & ( x > y ) \\ y & ( x < y )\end{matrix} \\ min ( x , y ) = \{ \begin{matrix}x & ( x < y ) \\ y & ( x > y )\end{matrix}$$

The parameters α, β, and γ of the speed coefficient are speed constants set for the edge information of the selected edge, and are the same as those in Expression (1) when α=1.8, β=0.3, and γ=1.0, for example. According to Non-Patent Literature 1, common fixed values are simply used as the parameters α, β, and γ at all the edges. On the other hand, according to the present embodiment, the movement speed calculation unit 150 adjusts the parameters α, β, and γ of the speed coefficient in accordance with a case where passing people exist. For example, in a case where a large number of people proceed in the X direction, when the movement speed in the Y direction is calculated, the movement speed calculation unit 150 adjusts the parameters α, β, and γ by increasing a value of a, decreasing a value of β, and decreasing a value of γ. How to adjust the parameters α, β, and γ of the speed coefficient may be previously set in accordance with the head count in the section, the head count ratio, or the like. As described above, the movement speed calculation unit 150 adjusts the parameters α, β, and γ of the speed coefficient in accordance with the number of the moving agents proceeding in the one direction and the number of the moving agents proceeding in the other direction at each of the edges. The movement speed calculation unit 150 calculates the movement speed following the above-described Expression (4) using the parameters α, β, and γ of speed counting after adjustment.

In addition, the movement speed calculation unit 150 may adjust the parameters α, β, and γ in accordance with attributes of the edges which change in accordance with the time of day. For example, to reproduce a situation or the like where stoppage occurs when the speed is suddenly decreased even when the population density is low since an umbrella is used in a rainy day, the movement speed calculation unit 150 increases α. When α is increased, a reduction rate of the speed along with an increase in the population density is increased. In addition, after the reduction rate of the speed is determined by α, the movement speed calculation unit 150 sets β in accordance with at which degree of the population density the movement is desired to be stopped. For example, the same α and β as those when it is sunny may be used for an edge under a roof such as an underpass or an arcaded street even in a rainy day. In addition, with regard to γ, the movement speed calculation unit 150 is used to decrease γ in accordance with a change of darkness at night or the like. The movement speed calculation unit 150 performs the adjustment in a manner that γ of an edge that is bright even at night is not much decreased. For this reason, α, β, and γ are set for each edge. In addition, to reproduce sunset over time during the simulation, sudden rainfall due to a weather change, or the like, α, β, and γ of each edge may be changed depending on the time of day. In this manner, the movement speed calculation unit 150 is set to adjust the parameters α, β, and γ in accordance with the attributes of each edge which change in accordance with the time of day.

The movement speed calculation unit 150 records the parameters α, β, and γ of the speed counting after the adjustment and the width sizes W_{X} and W_{Y} calculated by the forward area density calculation unit 140 in the edge variable record unit 180 as edge variables. The edge variables recorded in the edge variable record unit 180 are used for an adjustment by a weighting average or the like in a case, for example, where a change of results of the edge variables in the simulation at the time of day t is larger as compared with results of the edge variables at the previous time of day t−1.

With regard to each of the moving agents, the location update unit 160 updates the location of the moving agent of the location record unit 120 based on the movement speed calculated by the movement speed calculation unit 150. Hereinafter, an operation example of the location update unit 160 will be described.

For each moving agent, the location update unit 160 calculates the location information at t=k+1 using the location information at t=k which is recorded in the location record unit 120 and the movement speed vᵢ calculated by the movement speed calculation unit 150. Then, the location update unit 160 records the agent number and the location information at the time of day of t=k+1 with regard to each of the moving agents in the location record unit 120. When the moving agent that has reached the point of destination exists, the location update unit 160 records information indicating that the moving agent has already reached.

The determination unit 170 repeats a simulation based on each processing of the agent generation unit 110, the edge selection unit 130, the forward area density calculation unit 140, the movement speed calculation unit 150, and the location update unit 160 until a predetermined condition is satisfied. The determination unit 170 repeats the operation in which the operation at t=k is completed when the update of the location information for all the moving agents is completed, and the time of day is incremented to perform the operation at the next time of day. The determination unit 170 ends the simulation in a case where it has reached the execution time j.

The movement prediction device 100 reads out and outputs the simulation result of each of the moving agents from the location record unit 120. For the simulation result, the location information of each agent i=1, 2, 3, . . . , m is output at each time of day of t=0, 2, 3, . . . of each moving agent.

Next, an action of the movement prediction device 100 will be described.

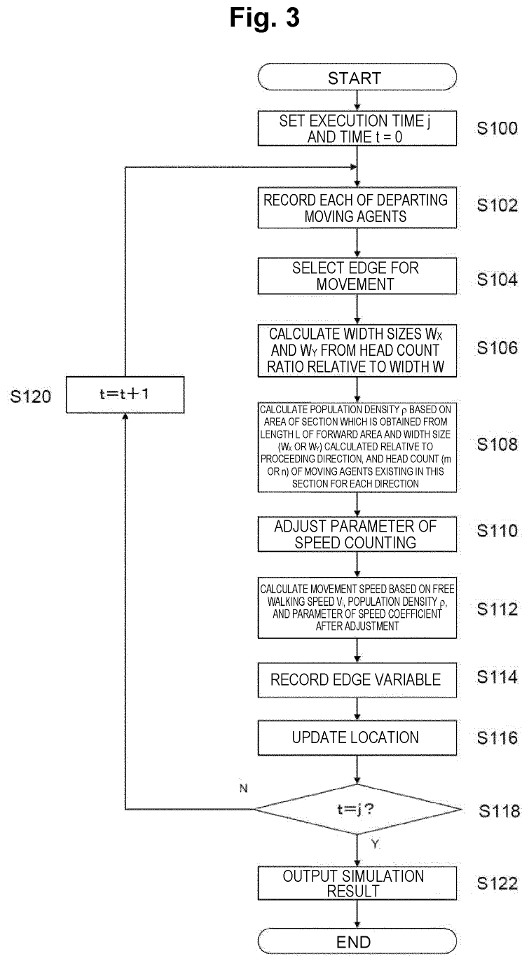

FIG. 3 is a flowchart illustrating a flow of movement prediction processing by the movement prediction device 100. The movement prediction processing is performed when the CPU 11 reads out the movement prediction program from the ROM 12 or the storage 14 to be developed and executed on the RAM 13. The movement prediction device 100 accepts the edge information and the agent information as inputs and performs the following processing.

In step S100, the CPU 11 sets the execution time of day j of the simulation, and also sets the time of day of t=0.

In step S102, the CPU 11 records each of the moving agents departing from the point of departure in accordance with the departure time of day of the agent information in the location record unit 120. Herein, the departure time of day of the agent information is set as k, and the agent at t=k is the moving agent.

In step S104, with regard to each of the moving agents, the CPU 11 selects an edge through which the moving agent moves based on the location of the moving agent, the point of destination of the agent information, and the edge information.

In step S106, the CPU 11 obtains the head count ratio between the head count of the moving agents travelling in the one direction and the head count of the moving agents travelling in the other direction at the selected edge for each direction. Next, the CPU 11 calculates the width sizes W_{X} and W_{Y} relative to the direction in which the moving agent proceeds from the head count ratio relative to the width W of the location.

In step S108, the CPU 11 calculates the population density ρ with regard to each of the moving agents following the above-described Expression (2). In the above-described Expression (2), in accordance with the travelling direction, the CPU 11 replaces the width W with the width size W_{X} or the width size W_{Y}, and replaces the head count N with the head count m or the head count n. The population density ρ is calculated based on the area of the section which is obtained from the length L of the forward area from the location of the agent and the width size (W_{X} or W_{Y}) calculated relative to the direction in which the agent proceeds, and the head count (m or n) of the moving agents existing in this section for each direction.

In step S110, the CPU 11 adjusts the parameters α, β, and γ of the speed coefficient with regard to each of the edges. The edge set as the adjustment target herein may be an edge set as a movement destination by the moving agent.

In step S112, with regard to each of the moving agents, the CPU 11 calculates the movement speed of the moving agent. The movement speed of the moving agent is calculated in accordance with the above-described Expression (4) based on the free walking speed Vᵢ of the agent information, the population density ρ calculated by the forward area density calculation unit 140, and the parameters α, β, and γ of the speed coefficient after the adjustment.

In step S114, the CPU 11 records the width sizes W_{X} and W_{Y} with regard to each of the edges and the parameters α, β, and γ of the speed coefficient after the adjustment with regard to each of the edges in the edge variable record unit 180 as edge variables.

In step S116, with regard to each of the moving agents, the CPU 11 updates the location of the moving agent of the location record unit 120 based on the movement speed calculated in step S112.

In step S118, the CPU 11 determines whether or not t=j is established, and shifts to step S122 when t=j is established, and shifts to step S120 when t=j is not established.

In step S120, the CPU 11 increments t=t+1, and shifts to step S102 to repeat the processing.

In step S122, the CPU 11 reads out and outputs the simulation result of each of the moving agents from the location record unit 120, and ends the processing.

As described above, the movement prediction device 100 according to the present embodiment can accurately perform the simulation of the movement by simulating the interaction based on the difference of the travelling direction.

In addition, with regard to the node edge model in which a representation of a path network is simplified for a purpose of increasing the speed, a simulation taking into account an influence of people passing each other may be performed using a simulator.

It is noted that the present invention is not limited to the above-described embodiment, and various modifications and applications can be made in a range without departing from the gist of this invention.

For example, instead of adjusting the parameters of the speed coefficient, a technique for setting an interlayer gap w_{g} for representing the passing in the opposite directions may be applied as a method for representing avoiding by mutual people using only the width size adjustment. With regard to the interlayer gap w_{g}, in the simulation, a single value is set for the number of entire agents existing at each of the edges. It is noted however that the value of the interlayer gap w_{g} may be set for each edge in accordance with the number of agents existing at each of the edges. A width size after an adjustment taking into account the interlayer gap w_{g} used by m people travelling in the X direction is set as W_{gX}, and a width size after an adjustment taking into account the interlayer gap w_{g} used by n people travelling in the Y direction is set as W_{gY}.

Where, the adjustment of the width size satisfies the following restriction.

W=W_{X}+W_{Y}=W_{gX}+W_{gY}+w_{g}

As illustrated in the following Expression (5), the width size W_{gX} in the one direction after the adjustment is obtained by the adjustment in accordance with a ratio between the interlayer gap w_{g} and the width size W_{X} in the one direction. Similarly, the width size W_{gY} in the other direction after the adjustment is obtained by the adjustment in accordance with a ratio between the interlayer gap w_{g} and the width size W_{Y} in the other direction.

$$[ Math . 7 ]$$

$${W}_{gX} = {W}_{X} - \frac{{W}_{X}}{W} {w}_{g} \\ {W}_{gY} = {W}_{Y} - \frac{{W}_{Y}}{W} {w}_{g} \qquad ( 5 )$$

Where W_{gX}=0 and W_{gY}=W_{Y} are set when W_{X}=0, and similarly W_{gY}=0 and W_{gX}=W_{X} are set when W_{Y}=0. The forward area density calculation unit 140 may use the width size W_{gX} in the one direction after the adjustment instead of the width size W_{X}, and the width size W_{gY} in the other direction after the adjustment instead of the width size W_{Y}. In this case, the above-described adjustment of the parameters of the speed counting in step S110 may be omitted. Accordingly, the population density may be calculated using the width size W_{gX} or W_{gY} after the adjustment, and the simulation taking into account the influence of people passing each other may be performed at a high speed.

It is noted that the movement prediction processing executed by the CPU that reads and executes software (program) according to the above-described respective embodiments may be executed by various types of processors other than the CPU. As the processors in this case, a PLD (Programmable Logic Device) in which a circuit configuration can be changed after manufacturing such as an FPGA (Field-Programmable Gate Array), a dedicated electric circuit serving as a processor having a circuit configuration dedicatedly designed to execute specific processing such as an ASIC (Application Specific Integrated Circuit), and the like are exemplified. In addition, the movement prediction processing may be executed by one of various types of these processors, or may be executed by a combination of two or more processors of the same type or different types (for example, a plurality of FPGAs, a combination of the CPU and the FPGA, and the like). In addition, hardware-like structures of various types of these processors are, more specifically, electric circuits obtained by combining circuit devices such as semiconductor devices.

In addition, according to the above-described respective embodiments, the mode has been described in which the movement prediction program is stored (installed) in the storage 14 in advance, but is not limited to this. The program may be provided in a mode of being stored in a non-transitory storage medium such as a CD-ROM (Compact Disk Read Only Memory), a DVD-ROM (Digital Versatile Disk Read Only Memory), and a USB (Universal Serial Bus) memory. In addition, the program may be in a mode of being downloaded from an external device via a network.

Regarding the above-described embodiments, the following supplementary items are further disclosed.

(Supplementary Item 1)

A movement prediction device comprising:

a memory; and

at least one processor connected to the memory,

the processor being configured to execute:

accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of the agent;

recording each of moving agents departing from the point of departure in accordance with the departure time of day of the agent information;

selecting, with regard to each of the moving agents, an edge through which the moving agent moves based on a location of the agent, the point of destination of the agent information, and the edge information;

obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge;

calculating, with respect to each of the moving agents, a population density based on an area of a section which is obtained from a previously set length of a forward area from the location of the agent and the width size calculated for the proceeding direction of the moving agent and the moving agents existing in the section for each direction;

calculating, with regard to each of the moving agents, a movement speed of the moving agent based on the free walking speed of the agent information, the calculated population density, and a predetermined parameter;

updating, with regard to each of the moving agents, the location of the moving agent based on the calculated movement speed; and

repeating a simulation based on each processing until a predetermined condition is satisfied.

(Supplementary Item 2)

A non-transitory storage medium storing a movement prediction program for causing a computer to execute:

accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of the agent;

recording each of moving agents departing from the point of departure in accordance with the departure time of day of the agent information;

selecting, with regard to each of the moving agents, an edge through which the moving agent moves based on a location of the agent, the point of destination of the agent information, and the edge information;

obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge;

calculating, with respect to each of the moving agents, a population density based on an area of a section which is obtained from a previously set length of a forward area from the location of the agent and the width size calculated for the proceeding direction of the moving agent and the moving agents existing in the section for each direction;

calculating, with regard to each of the moving agents, a movement speed of the moving agent based on the free walking speed of the agent information, the calculated population density, and a predetermined parameter;

updating, with regard to each of the moving agents, the location of the moving agent based on the calculated movement speed; and repeating a simulation based on each processing until a predetermined condition is satisfied.

### REFERENCE SIGNS LIST

100 Movement prediction device
110 Agent generation unit
120 Location record unit
130 Edge selection unit
140 Forward area density calculation unit
150 Movement speed calculation unit
160 Location update unit
170 Determination unit
180 Edge variable record unit

1. A movement prediction device comprising circuit configured to execute a method comprising:
repeating, based on a predetermined condition, a simulation including:
accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of an agent;
recording each of moving agents departing from the point of departure in accordance with the departure time of day of the agent information;
selecting, with regard to each of the moving agents, an edge through which the moving agent moves based on a location of the agent, the point of destination of the agent information, and the edge information;
obtaining a head count ratio between a head count of the moving agents travelling in one direction and a head count of the moving agents travelling in another direction for each direction at the selected edge, and calculate a width size relative to a proceeding direction of the moving agent from the head count ratio relative to a width of the edge;
calculating, with respect to each of the moving agents, a population density based on an area of a section which is obtained from a previously set length of a forward area from the location of the agent and the width size calculated for the proceeding direction of the moving agent and the moving agents existing in the section for each direction;
calculating, with regard to each of the moving agents, a movement speed of the moving agent based on the free walking speed of the agent information, the calculated population density, and a predetermined parameter; and
updating, with regard to each of the moving agents, the location of the moving agent based on the calculated movement speed.

2. The movement prediction device according to claim 1, wherein the predetermined parameter is adjusted at each of the edges in accordance with the number of the moving agents proceeding in the one direction and the number of the moving agents proceeding in the other direction.

3. The movement prediction device according to claim 1, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.

4. The movement prediction device according to claim 3, wherein the interlayer gap is set for either one of:
the number of entire agents existing at each of the edges, or
each edge in accordance with the number of agents existing at each of the edges in the simulation.

5. A computer-implemented method for predicting movement, the method comprising:
repeating, based on a predetermined condition, a simulation comprising:
accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of an agent;
recording each of moving agents departing from the point of departure in accordance with the departure time of day of the agent information;
selecting, with regard to each of the moving agents, an edge through which the moving agent moves based on a location of the agent, the point of destination of the agent information, and the edge information;
obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge;
calculating, with respect to each of the moving agents, a population density based on an area of a section which is obtained from a previously set length of a forward area from the location of the agent and the width size calculated for the proceeding direction of the moving agent and the moving agents existing in the section for each direction;
calculating, with regard to each of the moving agents, a movement speed of the moving agent based on the free walking speed of the agent information, the calculated population density, and a predetermined parameter; and
updating, with regard to each of the moving agents, the location of the moving agent based on the calculated movement speed.

6. A computer-readable non-transitory storage medium storing a computer-executable program instructions that when executed by a processor cause a computer to execute a method comprising:
repeating, based on a predetermined condition, a simulation comprising:
accepting inputs of edge information related to each of edges indicating paths connecting respective nodes, and agent information with regard to each of a plurality of agents which sets a departure time of day, a point of departure among the respective nodes, a point of destination among the respective nodes, and a free walking speed of an agent;
recording each of moving agents departing from the point of departure in accordance with the departure time of day of the agent information;
selecting, with regard to each of the moving agents, an edge through which the moving agent moves based on a location of the agent, the point of destination of the agent information, and the edge information;
obtaining a head count ratio between a head count of the moving agents travelling in one direction and a head count of the moving agents travelling in another direction for each direction at the selected edge, and calculating a width size relative to a proceeding direction of the moving agent from the head count ratio relative to a width of the edge;
calculating, with respect to each of the moving agents, a population density based on an area of a section which is obtained from a previously set length of a forward area from the location of the agent and the width size calculated for the proceeding direction of the moving agent and the moving agents existing in the section for each direction;
calculating, with regard to each of the moving agents, a movement speed of the moving agent based on the free walking speed of the agent information, the calculated population density, and a predetermined parameter; and
updating, with regard to each of the moving agents, the location of the moving agent based on the calculated movement speed.

7. The movement prediction device according to claim 1, wherein each agent represents a pedestrian on a street.

8. The movement prediction device according to claim 1, wherein the simulation simulates movement of people, and
wherein each edge represents a path connecting a plurality of nodes.

9. The movement prediction device according to claim 2, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.

10. The computer-implemented method according to claim 5, wherein the predetermined parameter is adjusted at each of the edges in accordance with the number of the moving agents proceeding in the one direction and the number of the moving agents proceeding in the other direction.

11. The computer-implemented method according to claim 5, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.

12. The computer-implemented method according to claim 5, wherein each agent represents a pedestrian on a street.

13. The computer-implemented method according to claim 5, wherein the simulation simulates movement of people, and
wherein each edge represents a path connecting a plurality of nodes.

14. The computer-readable non-transitory storage medium according to claim 6, wherein the predetermined parameter is adjusted at each of the edges in accordance with the number of the moving agents proceeding in the one direction and the number of the moving agents proceeding in the other direction.

15. The computer-readable non-transitory storage medium according to claim 6, wherein each agent represents a pedestrian on a street.

16. The computer-readable non-transitory storage medium according to claim 6,
wherein the simulation simulates movement of people, and
wherein each edge represents a path connecting a plurality of nodes.

17. The computer-readable non-transitory storage medium according to claim 6, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.

18. The computer-implemented method according to claim 10, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.

19. The computer-implemented method according to claim 11, wherein the interlayer gap is set for either one of:
the number of entire agents existing at each of the edges, or
each edge in accordance with the number of agents existing at each of the edges in the simulation.

20. The computer-readable non-transitory storage medium according to claim 14, wherein
the width size relative to the proceeding direction is calculated with regard to a width size in the one direction and a width size in the other direction,
the width size in the one direction is adjusted in accordance with a ratio between an interlayer gap for representing passing in opposite directions and the width size in the one direction, and
the width size in the other direction is adjusted in accordance with a ratio between the interlayer gap and the width size in the other direction.
